(19) United States
(12) Patent Application Publication
(10) Pub. No.: US 2015/0022735 A1
(43) Pub. Date: Jan. 22, 2015

(54) Touch Panel

(71) Applicant: LIYITEC INCORPORATED, Taoyuan County (TW)

(72) Inventor: Shu-Chen Hsu, Taoyuan County (TW)

(21) Appl. No.: 14/330,014

(22) Filed: Jul. 14, 2014

(30) Foreign Application Priority Data
Jul. 18, 2013 (TW) 102213582

(51) Int. Cl. G06F 3/047; G06F 3/046; G06F 3/044

(52) U.S. Cl. CPC G06F 3/047; G06F 3/044; G06F 3/046; G06F 2203/04106; G06F 2203/04112
USPC 349/12

(57) ABSTRACT

The present invention provides a touch panel, which comprises an insulating layer, a first electrode group, and a second electrode group. The insulating layer comprises a bottom surface and a top surface. The first electrode group is formed on the bottom surface and comprises multiple first inductive electrodes arranged abreast. Each first inductive electrode comprises multiple inductive lines arranged abreast equidistantly and a gap is formed between any two neighboring inductive lines, which can improve the transmittance of the touch panel. The second electrode group is formed on the top surface and intersects the first electrode group at an angle, and the second electrode group comprises multiple second inductive electrodes arranged abreast. Each second inductive electrode comprises multiple inductive lines arranged abreast equidistantly and a gap is formed between any two neighboring inductive lines, which can improve the transmittance of the touch panel.

### BACKGROUND OF THE INVENTION

1. Field of the Invention

The present invention relates to a touch panel; especially to a touch panel with improved transmittance.

2. Description of the Prior Art(s)

A conventional capacitive touch panel comprises multiple strings of first inductive electrodes and multiple strings of second inductive electrodes, which are respectively formed on a surface of a substrate. The strings of the first inductive electrodes are set on the surface of the substrate and intersect the strings of the second inductive electrodes at an angle. An insulating layer is inserted between the strings of the first inductive electrodes and the strings of the second inductive electrodes, or multiple bridge structures are mounted in every intersection of the strings of the first inductive electrodes and the strings of the second inductive electrodes to prevent inductive errors occurring from the strings of the first inductive electrodes stacked on or contacting the strings of the second inductive electrodes.

However, the strings of the first inductive electrodes and the strings of the second inductive electrodes are both made from indium tin oxide (ITO), which will reduce a transmittance of the conventional capacitive touch panel. The insulating layer or the bridge structures also reduce the transmittance or blur the conventional capacitive touch panel. Said problems need to be solved to meet the requirement of high resolution and brightness in the field of touch panels.

To overcome the shortcomings, the present invention provides a touch panel to mitigate or obviate the aforementioned problems.

### SUMMARY OF THE INVENTION

The objective of the present invention is to improve the transmittance of the touch panel to meet the requirement of high resolution and brightness in the field of touch panels.

The present invention provides a touch panel. The touch panel comprises an insulating layer, a first electrode group, and a second electrode group.

The insulating layer comprises a bottom surface and a top surface.

The first electrode group is formed on the bottom surface of the insulating layer and comprises multiple first inductive electrodes arranged abreast. Each first inductive electrode comprises multiple inductive lines arranged abreast equidistantly with a gap formed between any two neighboring inductive lines for improving the transmittance of the touch panel.

The second electrode group is formed on the surface of the insulating layer and intersects the first electrode group at an angle, and the second electrode group comprises multiple second inductive electrodes arranged abreast. Each second inductive electrode comprises multiple inductive lines arranged abreast equidistantly with a gap formed between any two neighboring inductive lines for improving the transmittance of the touch panel.

Other objectives, advantages and novel features of the invention will become more apparent from the following detailed description when taken in conjunction with the accompanying drawings.

### BRIEF DESCRIPTION OF THE DRAWINGS

FIG. 1 is a top view of a touch panel in accordance with Embodiment 1 of the present invention;

FIG. 2 is an exploded perspective view of the touch panel in FIG. 1;

FIG. 3A is a side view of the touch panel in FIG. 1;

FIG. 3B is an enlarged side view in partial section of the touch panel in FIG. 3A;

FIG. 4 is an exploded perspective view of a touch panel in accordance with Embodiment 2 of the present invention;

FIG. 5 is a side view of the touch panel in FIG. 4.

### DETAILED DESCRIPTION OF THE PREFERRED EMBODIMENTS

### Embodiment 1

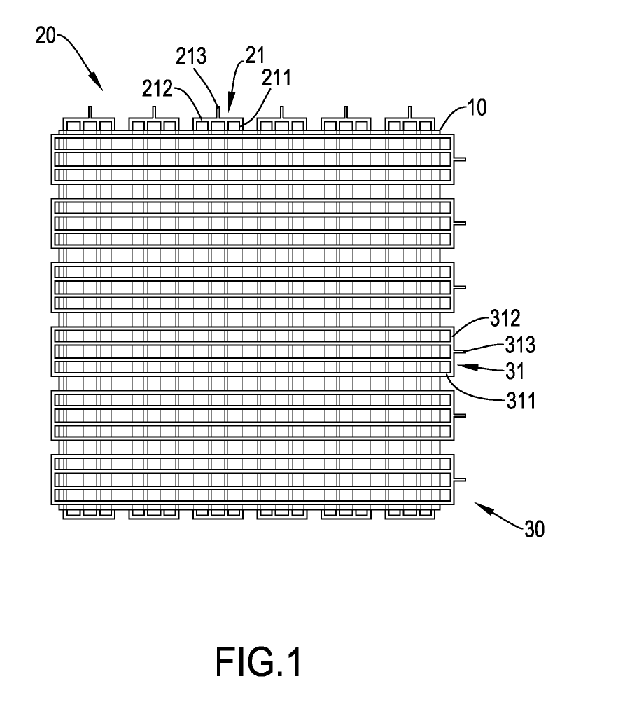

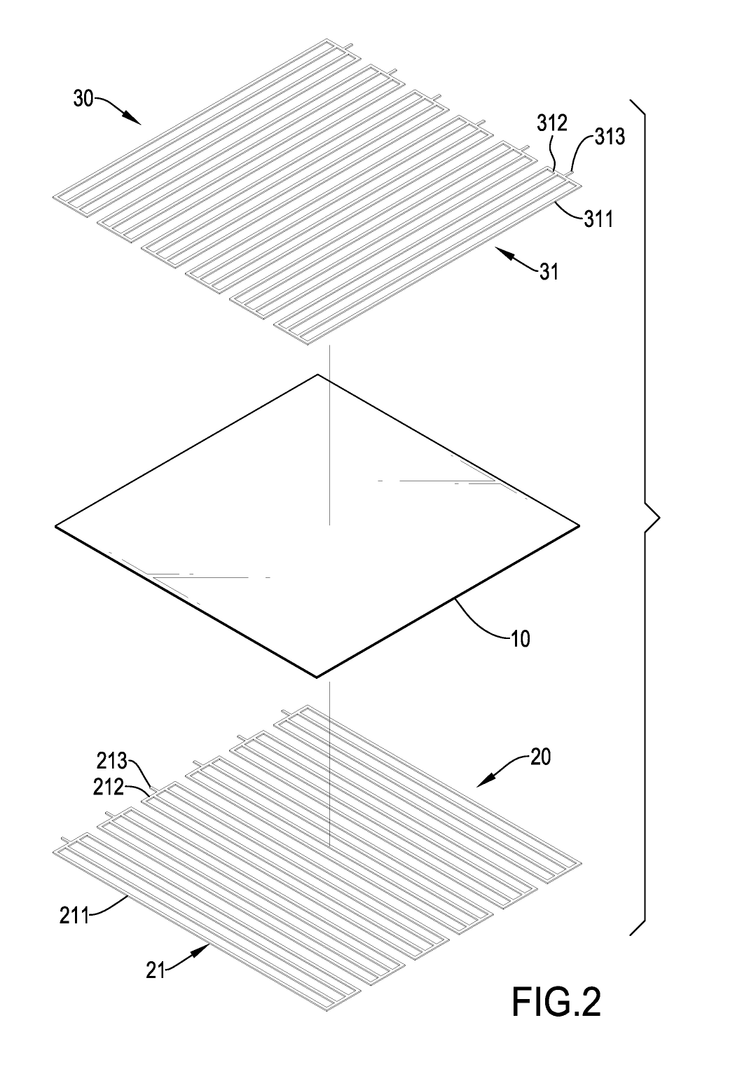

With reference to FIG. 1 to FIG. 2, a touch panel comprises an insulating layer 10, a first electrode group 20, and a second electrode group 30. The insulating layer 10 comprises a bottom surface and a top surface.

The first electrode group 20 is formed on the bottom surface of the insulating layer 10. The second electrode group 30 is formed on the top surface of the insulating layer 10 and intersects the first electrode group 20 at an angle. With reference to FIG. 1, the angle is, but not limited to, 90 degrees. The first electrode group 20 is made from, but not limited to, gold, silver, or copper. The second electrode group 30 is made from, but not limited to, gold, silver, or copper.

The touch panel can be further attached to a display or combined with a substrate for use.

The first electrode group 20 comprises multiple first inductive electrodes 21 longitudinally arranged abreast on the bottom surface of the insulating layer 10.

Each first inductive electrode 21 comprises four inductive lines 211, two secondary connecting lines 212, and a third connecting line 213, and each first inductive electrode 21 is elongated.

The inductive lines 211 are longitudinally and equidistantly arranged, and each inductive line 211 has a front end and a back end. A gap is formed between any two neighboring inductive lines 211. A width of the gap is larger than a line width of any one of the inductive lines 211.

One of the secondary connecting lines 212 is connected to the front ends of the inductive lines 211, and the other one of the secondary connecting lines 212 is connected to the back ends of the inductive lines 211. The third connecting line 213 is connected to the secondary connecting line 212 which is connected to the front ends of the inductive lines 211.

The number of the inductive lines 211 can be two, three, four, or above, depending on demands of users; the third connecting line 213 can be further connected to a touch-inductive device.

The second electrode group 30 comprises multiple second inductive electrodes 31 transversely arranged abreast on the top surface of the insulating layer 10.

Each second inductive electrode 31 comprises four inductive lines 311, two secondary connecting lines 312, and a third connecting line 313, and each second inductive electrode 31 is elongated.

The inductive lines 311 of the second inductive electrode 31 are transversely and equidistantly arranged and each inductive line 311 has a front end and a back end. A gap is formed between any two neighboring inductive lines 311 of the second inductive electrode 31. A width of the gap is larger than a line width of any one of the inductive lines 311 of the second inductive electrode 31.

One of the secondary connecting lines 312 of the second inductive electrode 31 is connected to the front ends of the inductive lines 311 of the second inductive electrode 31. The other one of the secondary connecting lines 312 of the second inductive electrode 31 is connected to the back ends of the inductive lines 311 of the second inductive electrode 31. The third connecting line 313 of the second inductive electrode 31 is connected to the secondary connecting line 312 which is connected to the front ends of the inductive lines 311 of the second inductive electrode 31.

The number of the inductive lines 311 of the second inductive electrode 31 can be two, three, four, or above, depending on demands of users; the third connecting line 313 can be further connected to a touch-inductive device.

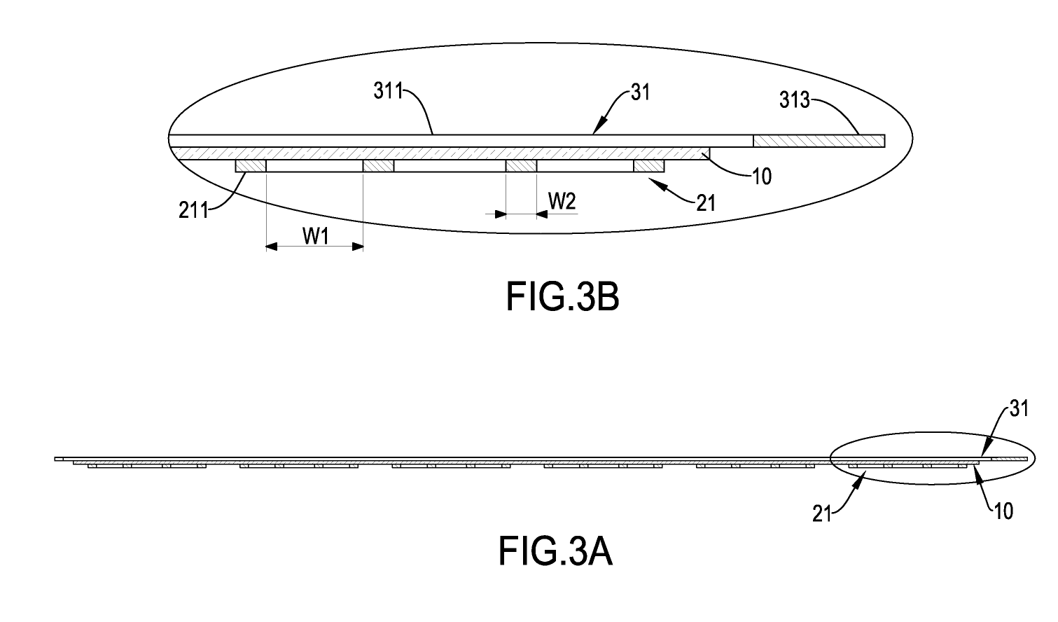

With reference to FIG. 3A and FIG. 3B, the width of the gap between any two neighboring inductive lines 211 of the first inductive electrode 21 is W1 and the line width of any one of the inductive lines 211 of the first inductive electrode 21 is W2. A ratio of W2 to W1 is 1:3. The width of the gap between any the two neighboring inductive lines 311 of the second inductive electrode 31 is equal to the width of the gap W1 between any two neighboring inductive lines 211 of the first inductive electrode 21. The line width of any one of the inductive lines 311 of the second inductive electrode 31 is equal to the line width W2 of any one of the inductive lines 211 of the first inductive electrode 21.

### Embodiment 2

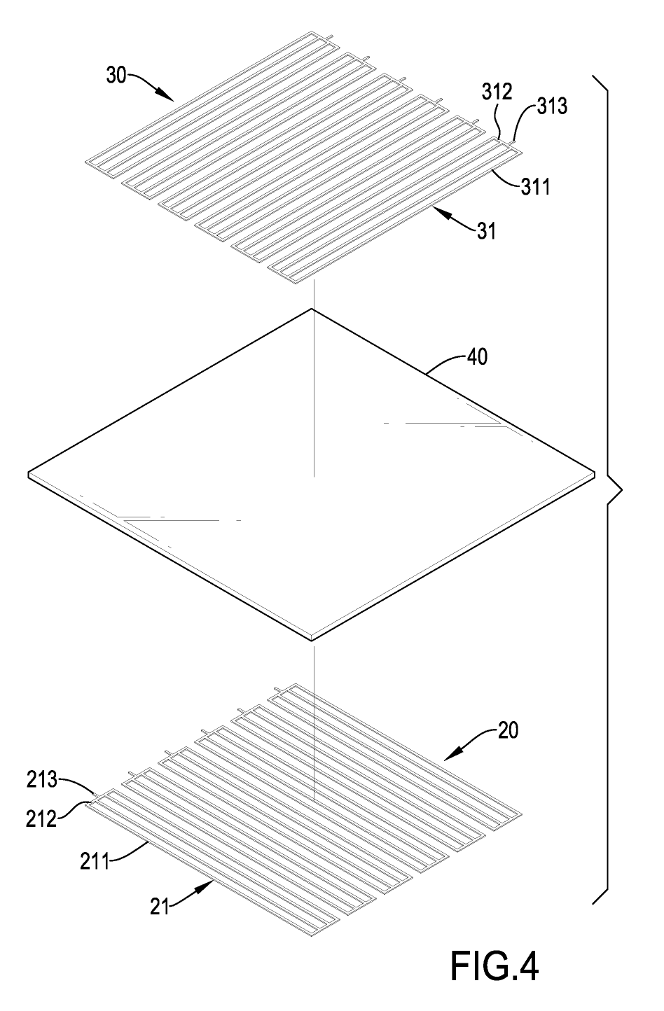

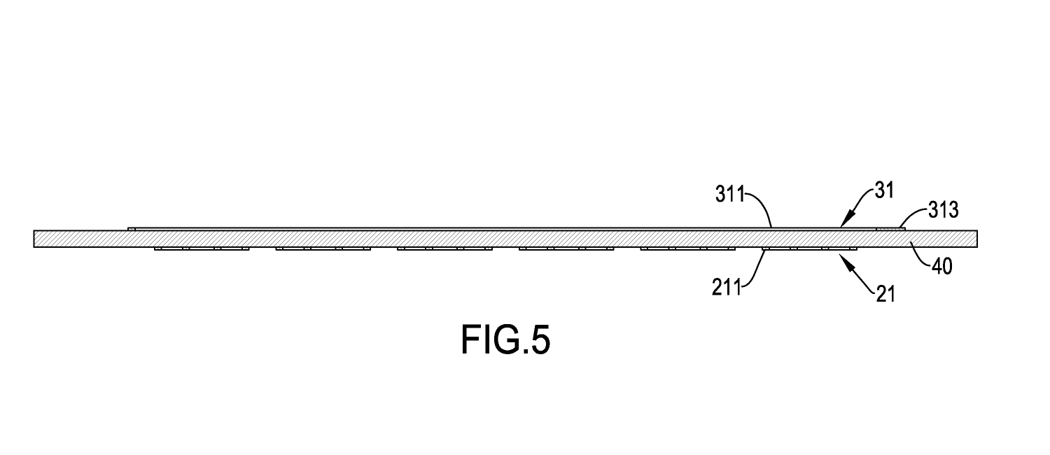

The touch panel in Embodiment 2 is similar to the touch panel of Embodiment 1. With reference to FIG. 4 and FIG. 5, the difference between Embodiment 2 and Embodiment 1 is that the insulating layer is replaced by a substrate 40. The substrate 40 comprises a bottom surface and a top surface and is a glass substrate. The first electrode group 20 is formed on the bottom surface of the substrate 40. The second electrode group 30 is formed on the top surface of the substrate 40. The ratio of W2 to W1 is 1:10. The substrate 40 can be a soft display substrate.

### Comparative Embodiment

Comparing the transmittance of the touch panel of present invention in Embodiment 1 and the conventional capacitive touch panel by UV-VIS-NIR spectrum, the transmittance of the touch panel of present invention is 95.0% and the transmittance of the conventional capacitive touch panel is 91.5%. In accordance with Embodiment 1 and Embodiment 2, the first electrode group 20 and the second electrode group 30 are respectively disposed on the bottom surface and the top surface of the insulating layer 10 or of the substrate 40 to electrically insulate the first electrode group 20 and the second electrode group 30, thereby preventing contact between the first electrode group 20 and the second electrode group from causing inductive errors. With the gap between any two neighboring inductive lines 211 of the first inductive electrode 21 and the gap between any two neighboring inductive lines 311 of the second inductive electrode 311, the first and second inductive electrodes 21, 31 are elongated with hollow-out patterns. Furthermore, the width of the gap between any two neighboring inductive lines 211 of the first inductive electrode 21 is larger than the line width of any one of the inductive lines 211 of the first inductive electrode 21, and the width of the gap between any two inductive lines 311 of the second inductive electrode 31 is larger than the line width of any one of the inductive lines 311 of the second inductive electrode 31. Such an arrangement overcomes the drawbacks of a conventional touch panel fully covered with a transparent electrode layer, and improves the transmittance, the brightness and the resolution of the touch panel.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A touch panel comprising:
an insulating layer comprising a bottom surface and a top surface;
a first electrode group formed on the bottom surface of the insulating layer and comprising
multiple first inductive electrodes arranged abreast, each first inductive electrode comprising
multiple inductive lines arranged abreast equidistantly with a gap formed between any two neighboring inductive lines; and
a second electrode group formed on the top surface of the insulating layer and intersecting the first electrode group at an angle, the second electrode group comprising
multiple second inductive electrodes arranged abreast, each second inductive electrode comprising
multiple inductive lines arranged abreast equidistantly with a gap between any two neighboring inductive lines of the second inductive electrodes.

2. The touch panel as claimed in claim 1, wherein each first inductive electrode comprises four inductive lines and two secondary connecting lines; and
each inductive line of the first inductive electrode further comprises a front end and a back end, one of the secondary connecting lines of the first inductive electrode is connected to the front ends of the inductive lines of the first inductive electrode, and the other one of the secondary connecting lines of the first inductive electrode is connected to the back ends of the inductive lines of the first inductive electrode.

3. The touch panel as claimed in claim 1, wherein each second inductive electrode comprises four inductive lines and two secondary connecting lines; and
each inductive line of the second inductive electrode further comprises a front end and a back end, one of the secondary connecting lines of the second inductive electrode is connected to the front ends of the inductive lines of the second inductive electrode and the other one of the secondary connecting lines of the second inductive electrode is connected to the back ends of the inductive lines of the second inductive electrode.

4. The touch panel as claimed in claim 2, wherein each second inductive electrode comprises four inductive lines and two secondary connecting lines; and
each inductive line of the second inductive electrode further comprises a front end and a back end, one of the secondary connecting lines of the second inductive electrode is connected to the front ends of the inductive lines of the second inductive electrode and the other one of the secondary connecting lines of the second inductive electrode is connected to the back ends of the inductive lines of the second inductive electrode.

5. The touch panel as claimed in claim 1, wherein a ratio of a line width of the inductive line of the first inductive electrode and a width of the gap between any two neighboring inductive lines of the first inductive electrode is 1:3 to 1:10; and
a ratio of a line width of the inductive line of the second inductive electrode and a width of the gap between any two neighboring inductive lines of the second inductive electrode is 1:3 to 1:10.

6. The touch panel as claimed in claim 2, wherein a ratio of a line width of the inductive line of the first inductive electrode and a width of the gap between any two neighboring inductive lines of the first inductive electrode is 1:3 to 1:10; and
a ratio of a line width of the inductive line of the second inductive electrode and a width of the gap between any two neighboring inductive lines of the second inductive electrode is 1:3 to 1:10.

7. The touch panel as claimed in claim 3, wherein a ratio of a line width of the inductive line of the first inductive electrode and a width of the gap between any two neighboring inductive lines of the first inductive electrode is 1:3 to 1:10; and
a ratio of a line width of the inductive line of the second inductive electrode and a width of the gap between any two neighboring inductive lines of the second inductive electrode is 1:3 to 1:10.

8. The touch panel as claimed in claim 4, wherein a ratio of a line width of the inductive line of the first inductive electrode and a width of the gap between any two neighboring inductive lines of the first inductive electrode is 1:3 to 1:10; and
a ratio of a line width of the inductive line of the second inductive electrode and a width of the gap between any two neighboring inductive lines of the second inductive electrode is 1:3 to 1:10.

9. The touch panel as claimed in claim 1, the insulating layer is a substrate.
